(19) United States
(12) Patent Application Publication
(10) Pub. No.: US 2015/0375798 A1
(43) Pub. Date: Dec. 31, 2015

(54) ELASTICALLY AVERAGED ALIGNMENT SYSTEMS AND METHODS

(71) Applicant: GM GLOBAL TECHNOLOGY OPERATIONS LLC, DETROIT, MI (US)

(72) Inventors: Steven E. Morris, Fair Haven, MI (US); Jennifer P. Lawall, Waterford, MI (US)

(21) Appl. No.: 14/319,683

(22) Filed: Jun. 30, 2014

(51) Int. Cl. B62D 27/04; B62D 27/06

(52) U.S. Cl. CPC B62D 27/04; B62D 27/06

(57) ABSTRACT

In one aspect, an elastically averaged alignment system is provided. The system includes a first component comprising an alignment member having an inner wall defining a retention aperture, and a second component comprising an inner wall defining an alignment aperture. The inner wall includes a first wall and an opposed second wall, and the first wall includes a retention tab configured for insertion into the retention aperture. The alignment member is fabricated from an elastically deformable material such that when the alignment member is inserted into the alignment aperture, the alignment member elastically deforms to an elastically averaged final configuration to facilitate aligning the first component with the second component in a desired orientation.

### FIELD OF THE INVENTION

The subject invention relates to matable components and, more specifically, to elastically averaged matable components for alignment and retention.

### BACKGROUND

Components, in particular vehicular components which are to be mated together in a manufacturing process, may be mutually located with respect to each other by alignment features that are oversized holes and/or undersized upstanding bosses. Such alignment features are typically sized to provide spacing to freely move the components relative to one another to align them without creating an interference therebetween that would hinder the manufacturing process. One such example includes two-way and/or four-way male alignment features; typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignment may also affect the function and/or aesthetic appearance of the entire assembly. Regardless of whether such misalignment is limited to two components or an entire assembly, it can negatively affect function and may result in a perception of poor quality. Moreover, clearance between misaligned components may lead to relative motion therebetween, which may cause undesirable noise such as squeaking and rattling.

### SUMMARY OF THE INVENTION

In one aspect, an elastically averaged alignment system is provided. The system includes a first component comprising an alignment member having an inner wall defining a retention aperture, and a second component comprising an inner wall defining an alignment aperture. The inner wall includes a first wall and an opposed second wall, and the first wall includes a retention tab configured for insertion into the retention aperture. The alignment member is fabricated from an elastically deformable material such that when the alignment member is inserted into the alignment aperture, the alignment member elastically deforms to an elastically averaged final configuration to facilitate aligning the first component with the second component in a desired orientation.

In another aspect, a vehicle is provided. The vehicle includes a body and an elastically averaged alignment system integrally arranged within the body. The elastically averaged alignment system includes a first component comprising an alignment member having an inner wall defining a retention aperture, and a second component comprising an inner wall defining an alignment aperture. The inner wall includes a first wall and an opposed second wall, and the first wall includes a retention tab configured for insertion into the retention aperture. The alignment member is fabricated from an elastically deformable material such that when the alignment member is inserted into the alignment aperture, the alignment member elastically deforms to an elastically averaged final configuration to facilitate aligning the first component with the second component in a desired orientation.

In yet another aspect, a method of manufacturing an elastically averaged alignment system is provided. The method includes forming a first component comprising an alignment member having an inner wall defining a retention aperture, forming a second component comprising an inner wall defining an alignment aperture, the inner wall having a first wall and an opposed second wall, the first wall including a retention tab configured for insertion into the retention aperture, and forming the alignment member from an elastically deformable material such that when the alignment member is inserted into the alignment aperture, the alignment member elastically deforms to an elastically averaged final configuration to facilitate aligning the first component and the second component in a desired orientation.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a perspective view of an exemplary elastically averaging mating system before assembly;

FIG. 2 is a perspective view of the system shown in FIG. 1 after assembly;

FIG. 3 is an enlarged view of an exemplary alignment member of the system shown in FIGS. 1 and 2;

FIG. 4 is a cross-sectional view of the system shown in FIG. 2 taken along section 4-4;

FIG. 5 is a cross-sectional view of the system shown in FIG. 2 taken along section 5-5; and

FIG. 6 is a cut-away view of a vehicle that may use the elastically averaged alignment system shown in FIGS. 1-5.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to the application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. In some embodiments, the elastically deformable component configured to have the at least one feature and associated mating feature disclosed herein may require more than one of such features, depending on the requirements of a particular embodiment. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned U.S. Pat. No. 8,695,201, the disclosure of which is incorporated by reference herein in its entirety. The embodiments disclosed above provide the ability to convert an existing component that is not compatible with the above-described elastic averaging principles, or that would be further aided with the inclusion of an elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are alignment and retention systems, as well as methods for elastically averaged mating assemblies. The alignment and retention systems include components having both male and female elastic alignment features that facilitate elastically averaged mating with another of the same or similar component. As such, the components may be generally modular and facilitate simple module manufacture, provide easy assembly into a system formed from the multiple modular components, and facilitate maintaining a proper coupling between, and desired orientation of, two or more components.

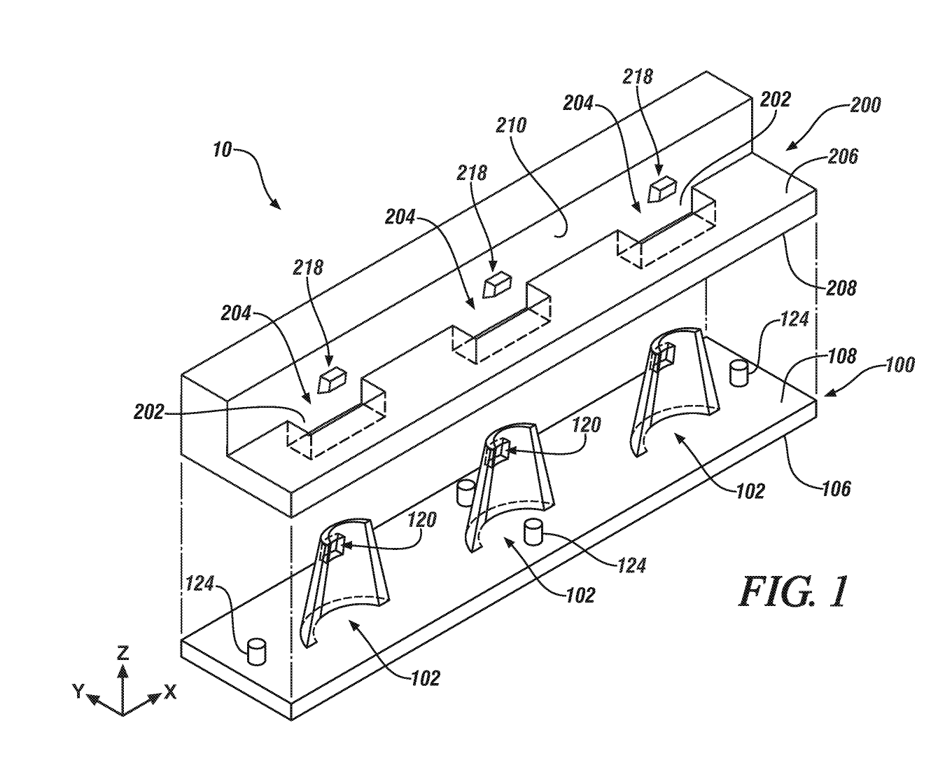

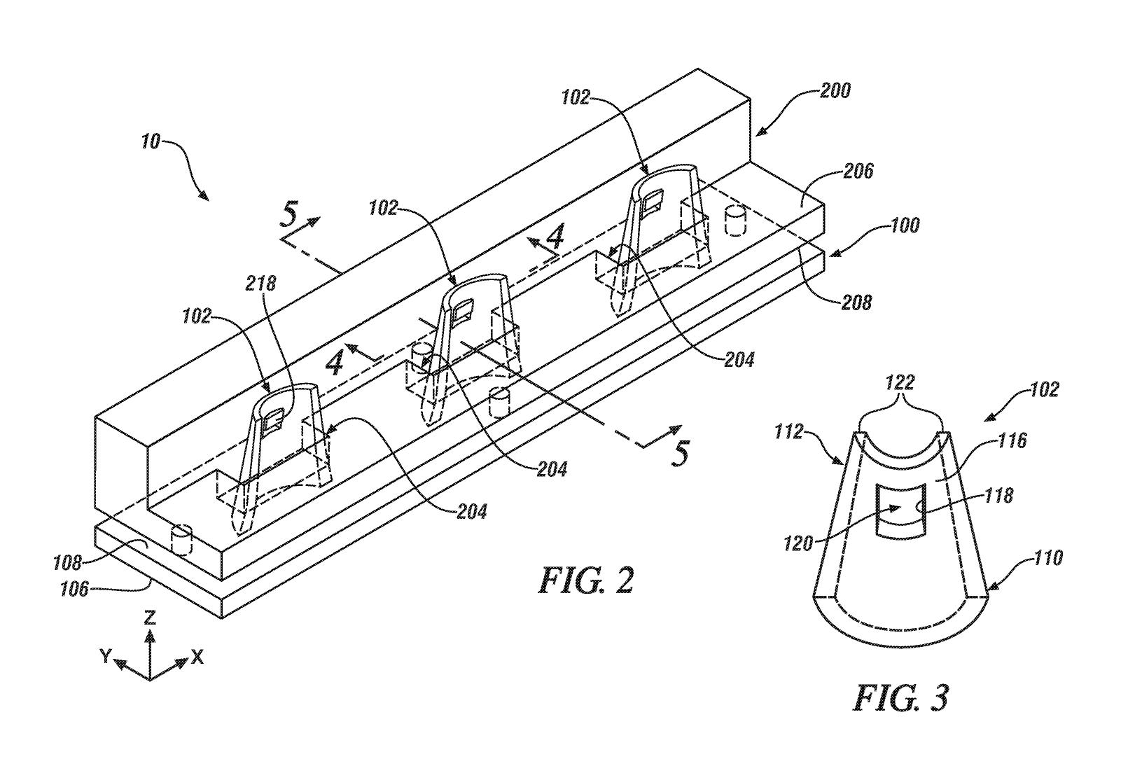

FIGS. 1 and 2 illustrate an exemplary elastically averaged alignment system 10 that generally includes a first component 100 to be mated to a second component 200.

First component 100 includes elastically deformable alignment members 102, and second component 200 includes an inner wall 202 defining alignment apertures 204. Alignment members 102 and alignment apertures 204 are fixedly disposed on or formed integrally with their respective component 100, 200 for proper alignment and orientation when components 100 and 200 are mated, as described herein in more detail. Although three alignment members 102 are illustrated in FIG. 1, component 100 may have any number of alignment members 102.

Elastically deformable alignment member 102 is configured and disposed to interferingly, deformably, and matingly engage wall 202 of alignment aperture 204, as discussed herein in more detail, to precisely align first component 100 with second component 200 in two or four directions, such as the +/− x-direction and the +/− y-direction of an orthogonal coordinate system, for example, which is herein referred to as two-way and four-way alignment. Moreover, elastically deformable alignment member 102 matingly engages alignment aperture 204 to facilitate a stiff and rigid connection between first component 100 and second component 200, thereby reducing or preventing relative movement therebetween.

As illustrated in FIGS. 3-5, in the exemplary embodiment, first component 100 generally includes an outer face 106 and an inner face 108 from which alignment member 102 extends. Alignment member 102 is a curved, semi-circular or substantially semi-circular shape having a proximal end 110 coupled to inner face 108, and a distal end 112. However, alignment member 102 may have any cross-sectional shape that enables system 10 to function as described herein. Alignment member 102 includes a concave inner face 114, a convex outer face 116, an inner wall 118 defining a retention aperture 120, and edges 122 extending between proximal end 110 and distal end 112. As illustrated in FIG. 3, in the exemplary embodiment, edges 122 are tapered toward each other as they extend from proximal end 110 to distal end 112.

First component 100 may optionally include one or more stand-offs 124 for engaging and supporting second component 200. In the exemplary embodiment, first component 100 is fabricated from a rigid or semi-rigid material such as plastic. However, first component 100 may be fabricated from any suitable material that enables system 10 to function as described herein.

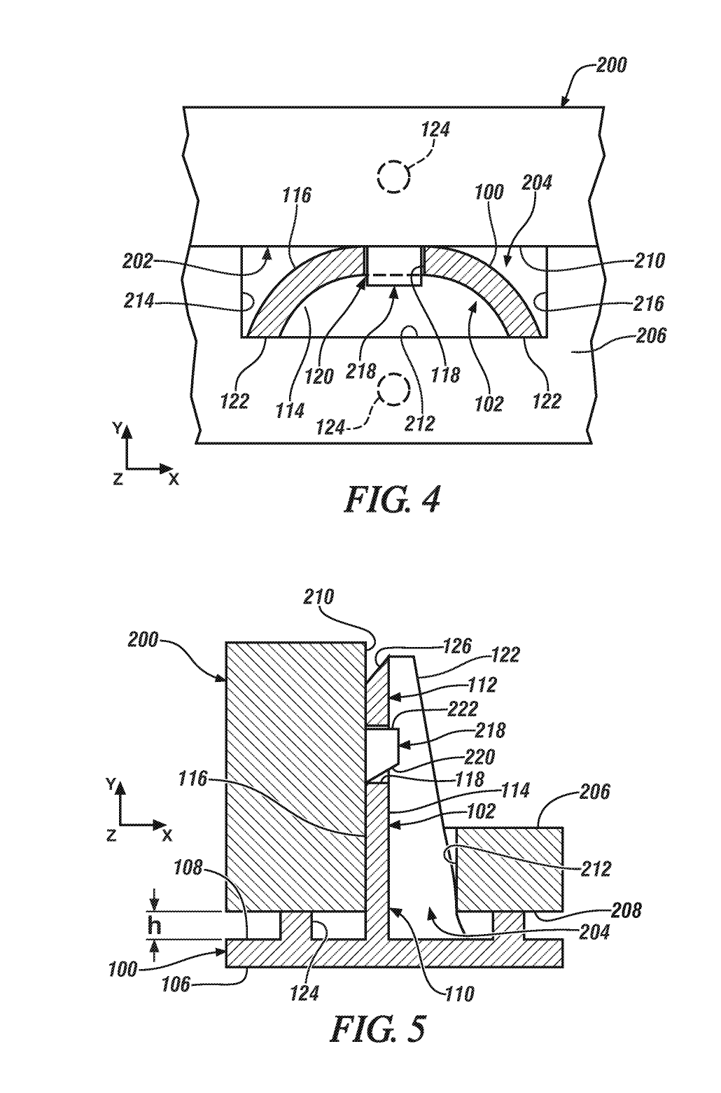

Second component 200 generally includes an outer face 206 and an inner face 208. Inner wall 202 includes opposed first and second walls 210 and 212, and opposed third and fourth walls 214 and 216 (FIG. 4). Alternatively, outer face 206 may not be continuous to include three alignment apertures 204 as shown in FIG. 1. Instead, component 200 may include a plurality of individual straps, clips or the like (not shown) extending from wall 210 that define each individual aperture 204. In the exemplary embodiment, alignment aperture 204 is illustrated as having a generally rectangular cross-section. Alternatively, alignment aperture 204 may have any shape that enables system 10 to function as described herein. For example, alignment aperture 204 may be an elongated slot with rounded ends (not shown). As shown in FIGS. 2 and 5, first wall 210 extends above alignment aperture 204 and includes a retention tab 218 extending therefrom configured to be received by retention aperture 120 when alignment member 102 is inserted into alignment aperture 204. Alternatively, retention tab 218 may be located within alignment aperture 204. In the exemplary embodiment, second component 200 is fabricated from a rigid material such as sheet metal. However, second component 200 may be fabricated from any suitable material that enables system 10 to function as described herein.

While not being limited to any particular structure, first component 100 may be an interior trim of a vehicle with the customer-visible side being outer face 106. Second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage alignment aperture 204, a diameter or cross-section of alignment aperture 204 is less than or smaller than the diameter or cross-section of respective alignment member 102, which creates a purposeful interference fit between the elastically deformable alignment member 102 and alignment aperture 204. As such, when inserted into alignment aperture 204, portions of the elastically deformable alignment member 102 elastically deform to an elastically averaged final configuration that aligns first component 100 within the alignment aperture 204 in two or four planar orthogonal directions (the +/− x-direction and the +/− y-direction).

Retention tab 218 includes a ramped lead-in surface 220 and a retention surface 222. Lead-in surface 220 is configured to flex alignment member 102 outward and around retention tab 218 as alignment member 102 is inserted into alignment aperture 204, and retention surface 222 is configured to engage inner wall 118 after retention alignment member 102 flexes back inward and retention tab 218 is seated within retention aperture 120, to thereby facilitate preventing removal of alignment member 102 from alignment aperture 204. As such, the interaction between retention tab 218 and retention aperture 120 facilitates improved retention of alignment member 102 within alignment aperture 204. Additionally, alignment member distal end 112 may include a ramped lead-in surface 126 (FIG. 5) configured to improve insertion of alignment member 102 into alignment aperture 204 as alignment member 102 engages lead-in surface 220.

With further reference to FIGS. 1 and 5, standoffs 124 may be spaced relative to alignment member 102 such that they provide a support platform at a height “h” above first component inner face 108. Second component inner face 208 is in contact with standoffs 124 when elastically deformable alignment member 102 is inserted into alignment aperture 204. Standoffs 124 are disposed and configured to provide a final positional orientation between alignment aperture 204 and elastically deformable alignment member 102 at an elevation “h” above the base, inner face 108. While FIG. 1 depicts six standoffs 124 in the form of posts at a height “h” relative to component inner face 108, it will be appreciated that the scope of the invention is not so limited and also encompasses other numbers and shapes of standoffs 124 suitable for a purpose disclosed herein, and also encompasses a standoff in the form of a continuous ring (not shown) disposed around alignment member 102. Embodiments having such standoff arrangements are contemplated and considered within the scope of the invention disclosed herein. Moreover, while FIGS. 1 and 5 depict standoffs 124 integrally formed on inner face 108, it will be appreciated that a similar function may be achieved by integrally forming standoffs 124 on inner face 208, which is herein contemplated and considered to be within the scope of the invention disclosed herein. Alternatively, system 10 may not include standoffs.

As alignment member 102 is inserted into a respective alignment aperture 204, convex outer face 116 contacts first wall 210 and edges 122 contact second wall 212 (FIG. 4). As such, alignment member 102 elastically deforms within the alignment aperture 204 as described herein to align first component 100 in the +/− y-direction. Specifically, the curvature of faces 114, 116 is reduced and edges 122 are forced away from each other as alignment member 102 is squeezed between walls 210, 212, particularly at alignment member distal end 112. For example, alignment member 102 may become less semi-circular and more semi-elliptical after the elastic deformation. In other embodiments, convex outer face 116 and/or edges 122 may contact third and fourth walls 214, 216 to further align first component 100 in the +/− x-direction. In addition, lead-in surface 126 contacts lead-in surface 220, and alignment member 102 is flexed outward around retention tab 218 until retention tab is inserted or falls into retention aperture 120. As such, alignment member 102 flexes or springs back toward first wall 210 (FIG. 5) and retention tab facilitates aligning first component 100 in the +/− x-direction and the +/− z-direction. However, retention aperture 120 is sized larger than retention tab 218 to enable some movement of alignment member 102 as it elastically deforms within alignment aperture 204. In this position, alignment member inner wall 118 is seated against or proximate to retention surface 222 for engagement therewith to facilitate preventing removal of alignment member 102 from alignment aperture 204.

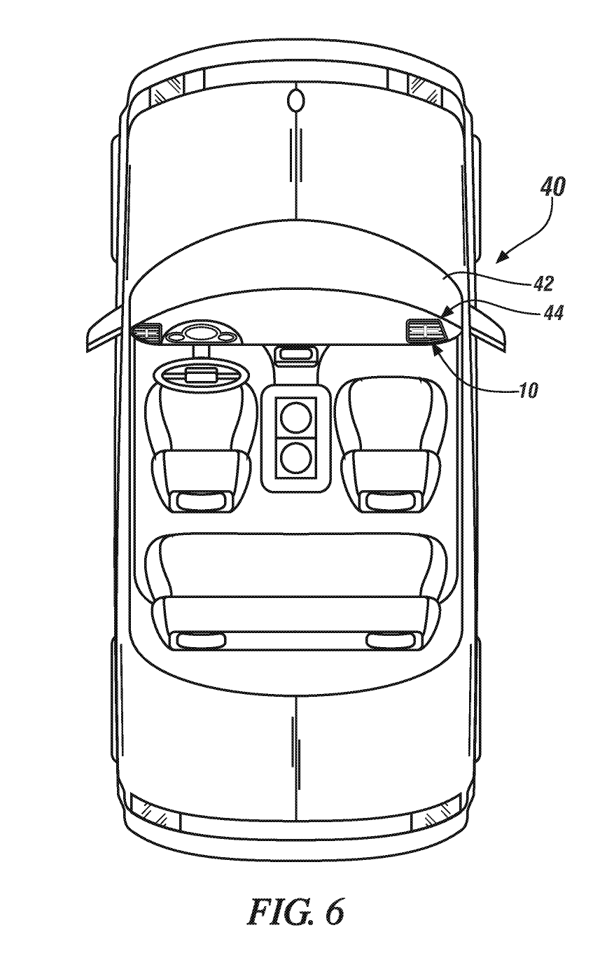

In view of the foregoing, and with reference now to FIG. 6, it will be appreciated that an embodiment of the invention also includes a vehicle 40 having a body 42 with an elastically averaging alignment system 10 as herein disclosed integrally arranged with the body 42. In the embodiment of FIG. 6, elastically averaging alignment system 10 is depicted forming at least a portion of a dashboard 44 of the vehicle 40. However, it is contemplated that an elastically averaging alignment system 10 as herein disclosed may be utilized with other multi-layered components of the vehicle 40.

An exemplary method of fabricating elastically averaged alignment system 10 includes forming first component 100 with at least one alignment member 102, and forming second component 200 with at least one inner wall 202 defining alignment aperture 204. Alignment member 102 is formed with concave inner face 114, convex outer face 116, and inner wall 118 defining retention aperture 120. Inner wall 202 is formed with retention tab 218 having lead-in surface 220 and retention surface 222. Alignment member 102 is formed from an elastically deformable material such that when alignment member 102 is inserted into alignment aperture 204, alignment member 102 elastically deforms to an elastically averaged final configuration to facilitate aligning first component 100 and second component 200 in a desired orientation.

Systems and methods for elastically averaging mating and alignment systems are described herein. The systems generally include a first component having at least one elastically deformable semi-circular alignment member positioned for insertion into a corresponding alignment aperture of a second component. The second component includes a retention tab configured to be seated within a retention aperture formed in the alignment member when the alignment member is inserted into the alignment aperture. Coupling between the first and second components is elastically averaged over the alignment members and respective alignment apertures to precisely mate the components in a desired orientation. Accordingly, the described systems and methods facilitate precise alignment and retention of two or more components in a desired orientation.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member having an inner wall defining a retention aperture; and
a second component comprising an inner wall defining an alignment aperture, the inner wall having a first wall and an opposed second wall, the first wall including a retention tab configured for insertion into the retention aperture,
wherein the alignment member is fabricated from an elastically deformable material such that when the alignment member is inserted into the alignment aperture, the alignment member elastically deforms to an elastically averaged final configuration to facilitate aligning the first component with the second component in a desired orientation.

2. The system of claim 1, wherein the alignment member is substantially semi-circular, the alignment member further comprising a concave inner face and a convex outer face.

3. The system of claim 2, wherein the convex outer face contacts the first wall, and wherein the alignment member includes first and second edges contacting the second wall.

4. The system of claim 3, wherein the alignment member first and second edges are angled inwardly toward each other.

5. The system of claim 1, wherein at least one of the retention tab and a distal end of the alignment member includes a ramped lead-in surface.

6. The system of claim 5, wherein the retention tab includes a retention surface configured to engage the alignment member inner wall to facilitate preventing removal of the alignment member from the alignment aperture.

7. The system of claim 1, wherein the first component comprises more than one of the elastically deformable alignment member and the second component comprises more than one of the alignment aperture, the more than one elastically deformable alignment members being geometrically distributed with respect to respective ones of the more than one alignment apertures, such that portions of the elastically deformable alignment member of respective ones of the more than one elastically deformable alignment members, when engaged with respective ones of the more than one alignment apertures, elastically deform to an elastically averaged final configuration that further aligns the first component with the second component in at least two of four planar orthogonal directions.

8. A vehicle comprising:
a body; and
an elastically averaged alignment system integrally arranged within the body, the elastically averaged alignment system comprising:
a first component comprising an alignment member having an inner wall defining a retention aperture; and
a second component comprising an inner wall defining an alignment aperture, the inner wall having a first wall and an opposed second wall, the first wall including a retention tab configured for insertion into the retention aperture,
wherein the alignment member is fabricated from an elastically deformable material such that when the alignment member is inserted into the alignment aperture, the alignment member elastically deforms to an elastically averaged final configuration to facilitate aligning the first component with the second component in a desired orientation.

9. The vehicle of claim 8, wherein the alignment member is substantially semi-circular, the alignment member further comprising a concave inner face and a convex outer face.

10. The vehicle of claim 9, wherein the convex outer face contacts the first wall, and wherein the alignment member includes first and second edges contacting the second wall.

11. The vehicle of claim 10, wherein the alignment member first and second edges are angled inwardly toward each other.

12. The vehicle of claim 8, wherein at least one of the retention tab and a distal end of the alignment member includes a ramped lead-in surface.

13. The vehicle of claim 12, wherein the retention tab includes a retention surface configured to engage the alignment member inner wall to facilitate preventing removal of the alignment member from the alignment aperture.

14. The vehicle of claim 8, wherein the first component comprises a plurality of the alignment members, and the second component comprises a plurality of the alignment apertures, wherein each of the alignment members, when inserted into one of the alignment apertures, elastically deforms to an elastically averaged final configuration such that a manufacturing variance of each of the first and second components is averaged over the total of the alignment members.

15. A method of manufacturing an elastically averaged alignment system, the method comprising:
forming a first component comprising an alignment member having an inner wall defining a retention aperture;
forming a second component comprising an inner wall defining an alignment aperture, the inner wall having a first wall and an opposed second wall, the first wall including a retention tab configured for insertion into the retention aperture; and
forming the alignment member from an elastically deformable material such that when the alignment member is inserted into the alignment aperture, the alignment member elastically deforms to an elastically averaged final configuration to facilitate aligning the first component and the second component in a desired orientation.

16. The method of claim 15, further comprising forming the alignment member as substantially semi-circular with a concave inner face and a convex outer face.

17. The method of claim 15, further comprising forming the alignment member with first and second edges angled inwardly toward each other.

18. The method of claim 15, further comprising forming at least one of the retention tab and a distal end of the alignment member with a ramped lead-in surface.

19. The method of claim 15, further comprising forming the retention tab with a retention surface configured to engage the alignment member inner wall to facilitate preventing removal of the alignment member from the alignment aperture.

20. The method of claim 15, further comprising forming the first component with a plurality of the alignment members, and forming the second component with a plurality of the alignment apertures, wherein each of the alignment members, when inserted into one of the alignment apertures, elastically deforms to an elastically averaged final configuration such that a manufacturing variance of each of the first and second components is averaged over the total of the alignment members.
